(19) United States
(12) Patent Application Publication
(10) Pub. No.: US 2007/0300184 A1
(43) Pub. Date: Dec. 27, 2007

(54) Method and apparatus for displaying 3-dimensional menu, and computer readable recording medium storing computer readable program for executing the method

(75) Inventor: Keun-mi Song, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/698,076

(22) Filed: Jan. 26, 2007

(30) Foreign Application Priority Data
Jun. 26, 2006 (KR) 10-2006-0057631

(51) Int. Cl. G06F 17/00

(52) U.S. Cl. 715/810

(57) ABSTRACT

Provided are a method and apparatus for displaying a 3 dimensional (3D) menu, and a computer readable recording medium storing a computer readable program for executing the method. The method includes displaying at least one menu item on the screen, if a menu item is selected, dividing the selected menu item into at least one sub-menu item, and displaying on the screen the at least one sub-menu item that is divided. Accordingly, a user can intuitively, easily access and navigate a menu in a 3D space, and menu information and depth can be efficiently displayed.

### CROSS-REFERENCE TO RELATED PATENT APPLICATION

This application claims priority from Korean Patent Application No. 10-2006-0057631, filed on Jun. 26, 2006 in the Korean Intellectual Property Office, the disclosure of which is incorporated herein in its entirety by reference.

### BACKGROUND OF THE INVENTION

1. Field of the Invention

Methods and apparatuses consistent with the present invention relate to a user interface, and more particularly, to a displaying a three-dimensional (3D) menu.

2. Description of the Related Art

Recently, a try to use a 3D user interface in a Consumer Electronics (CE) environment has been performed. A 3D user interface in a digital television (DTV) provides an environment in which menu movement and selection in a 3D space can be performed using a remote control having a 6 Dimension of Free (DOF) wheel. However, a related art 3D user interface is complicated due to dynamic movement and various kinds of information displayed on a single screen and is difficult for a user to access.

### SUMMARY OF THE INVENTION

The present invention provides a method and apparatus for displaying a 3D menu, whereby a user can intuitively access and select a menu item, and a computer readable recording medium storing a computer readable program for executing the method.

According to an aspect of the present invention, there is provided a method of displaying a menu on a screen represented in a 3D space, the method comprising: displaying at least one menu item on the screen; if a menu item is selected, dividing the selected menu item into at least one sub-menu item; and displaying on the screen the at least one sub-menu item that is divided.

The at least one menu item and the at least one sub-menu item may be displayed with a graphic image having a 3D shape. The 3D shape may be a box shape.

The dividing may comprise dividing a box corresponding to the selected menu item into four boxes corresponding to sub-menu items.

The displaying of the at least one sub-menu item may further comprise arranging the at least one sub-menu item according to an arrangement pattern of the at least one menu item.

The arranging may further comprise displaying the at least one menu item and the at least one sub-menu item so that the at least one sub-menu item is moved by pushing the at least one menu item to the backside of the 3D space.

The method may further comprise displaying the selected menu item so that the selected menu item is moved to the center or to the very front of the 3D space, before the selected menu item is divided.

According to another aspect of the present invention, there is provided an apparatus for displaying a menu on a screen represented in a 3D space, the apparatus comprising: a display unit displaying the menu; an input unit for receiving a user's command; and a control unit, if a menu item displayed on the display unit is selected by means of the input unit, dividing the selected menu item into at least one sub-menu item and displaying on the display unit the at least one sub-menu item that is divided.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of a 3D menu display apparatus according to an exemplary embodiment of the present invention;

FIG. 2 is a flowchart illustrating a 3D menu display method according to an exemplary embodiment of the present invention;

FIG. 3 illustrates a menu item displayed on a screen represented in a 3D space, according to an exemplary embodiment of the present invention;

FIG. 4 illustrates a state where the menu item illustrated in FIG. 3 is divided, according to an exemplary embodiment of the present invention;

FIG. 5 illustrates sub-menu items arranged by dividing the menu item, which are illustrated in FIG. 4, according to an exemplary embodiment of the present invention;

FIG. 6 illustrates a state where one of the sub-menu items illustrated in FIG. 5 is selected and divided, according to an exemplary embodiment of the present invention;

FIG. 7 illustrates a state where the sub-menu items divided in FIG. 6 has been separated, according to an exemplary embodiment of the present invention; and

FIG. 8 illustrates a state where the sub-menu items separated in FIG. 7 have been moved, according to an exemplary embodiment of the present invention.

### DETAILED DESCRIPTION OF EXEMPLARY EMBODIMENT OF THE INVENTION

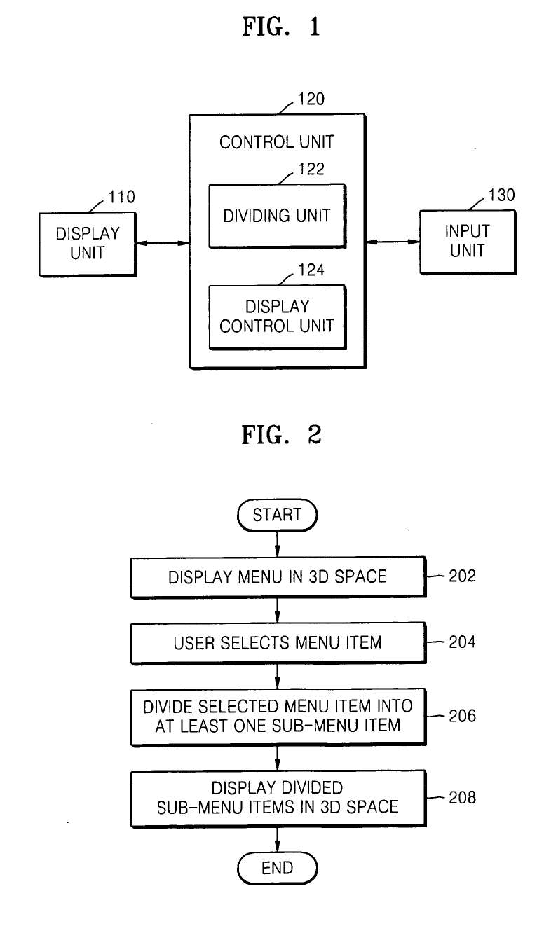

FIG. 1 is a block diagram of a 3D menu display apparatus according to an exemplary embodiment of the present invention.

Referring to FIG. 1, the 3D menu display apparatus includes a display unit 110, a control unit 120, and an input unit 130 and can be applied to any computing system, e.g., a DTV. The display unit 110 is to display a screen and menu represented in a 3D space and is not limited to a specific type of display device. The input unit 130 is a device, such as a remote control, for receiving a user's command to control a 3D screen and is not limited to a specific type of input device. If a user selects a menu item through the input unit 130, the control unit 120 processes the selection and displays a processing result on the display unit 110. The control unit 120 can be implemented so as to include a dividing unit 122 dividing a selected menu item into at least one sub-menu item and a display control unit 124 displaying the menu and the divided sub-menu items on the display unit 110.

FIG. 2 is a flowchart illustrating a 3D menu display method according to an exemplary embodiment of the present invention.

Referring to FIG. 2, the control unit 120 displays a menu on a screen represented in a 3D space in operation 202. Menu items of the menu can be displayed with a graphic image having a 3D shape. Sub-menu items can also be displayed with a graphic image having a 3D shape, wherein the 3D shape may be a shape obtained by dividing a menu item in an upper menu level or a shape the same as or similar to the menu item in the upper menu level. If a user selects a menu item from menu in operation 204, the control unit 120 determines sub-menu items associated with the selected menu item and divides the selected menu item into shapes corresponding to the sub-menu items in operation 206. The control unit 120 displays the divided sub-menu items by properly arranging the divided sub-menu items in the 3D space in operation 208. For example, if three sub-menu items exist in a lower level of the selected menu item, a graphic image corresponding to the selected menu item is divided into three graphic images and displayed, the three graphic images respectively correspond to the three sub-menu items, and the three graphic images are moved so that the three graphic images form a predetermined arrangement pattern. The sub-menu items may be arranged according to an arrangement pattern of menu items in the upper menu level. For example, the number of menu items in each menu level can be set to four, and the menu items in each menu level can be arranged to form a rectangle in the 3D space.

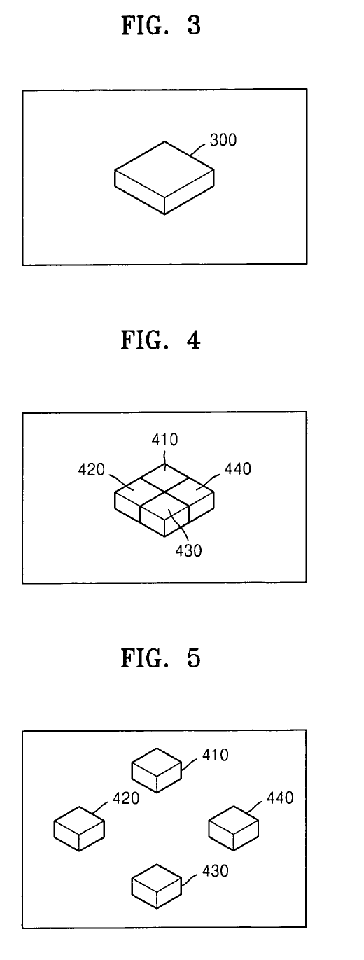

FIG. 3 illustrates a menu item 300 displayed on a screen represented in the 3D space, according to an exemplary embodiment of the present invention. Referring to FIG. 3, a single main box 300 is displayed in a form of hexahedron on an initial screen when a menu item of a main menu or a predetermined menu is selected. However, a shape of the menu item 300 is not limited to the box shape but can be any shape. Sub-menu items described below are same as well.

FIG. 4 illustrates a state where the menu item 300 illustrated in FIG. 3 is divided, according to an exemplary embodiment of the present invention, i.e., a result obtained when a user selects the main box 300. Referring to FIG.4, the main box 300 includes 4 sub-menu items and is divided into 3D shapes 410, 420, 430, and 440 corresponding to the 4 sub-menu items.

FIG. 5 illustrates sub-menu items 410, 420, 430, and 440 arranged by dividing the menu item 300, which are illustrated in FIG. 4, according to an exemplary embodiment of the present invention. Referring to FIG. 5, the four boxes 410, 420, 430, and 440 divided in FIG. 4 are separated and arranged. Although the four boxes 410, 420, 430, and 440 are displayed to form a rectangle in the 3D space, the arrangement of the sub-menu items 410, 420, 430, and 440 is not limited this. For example, if the menu item 300 is divided into six sub-menu items, six boxes can be arranged to form a hexagon or a circle.

In addition, a currently highlighted sub-menu item can be arranged so as to be placed at a predetermined position, e.g., the center of the 3D space or the center of the very front. In the current embodiment, a currently highlighted sub-menu item 430 is placed at the center of the very front. If a highlighted sub-menu item is changed by the user, the newly highlighted sub-menu item can be placed at the center of the very front by moving the sub-menu items 410, 420, 430, and 440. If the user selects another sub-menu item instead of the currently highlighted sub-menu item 430, e.g., if the user selects the box 420 in the left, the sub-menu items 410, 420, 430, and 440 are rotated so that the sub-menu item 420 is placed at the center of the very front before the sub-menu item 420 is divided.

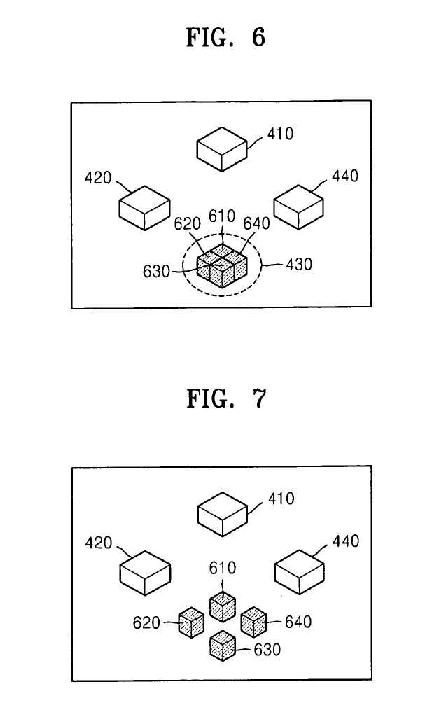

FIG. 6 illustrates a state where the sub-menu item 430 illustrated in FIG. 5 is selected and divided, according to an exemplary embodiment of the present invention. Referring to FIG. 6, the sub-menu item 430 is selected by the user and divided into four boxes 610, 620, 630, and 640 corresponding to four sub-menu items in a lower level of the sub-menu item 430.

FIG. 7 illustrates a state where the sub-menu items 610, 620, 630, and 640 divided in FIG. 6 has been separated, according to an exemplary embodiment of the present invention. Referring to FIG. 7, the four boxes 610, 620, 630, and 640 divided in FIG. 6 are separated.

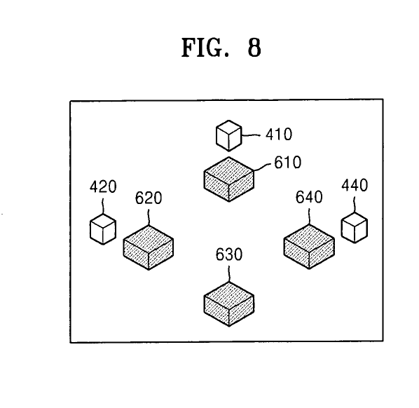

FIG. 8 illustrates a state where the sub-menu items 610, 620, 630, and 640 separated in FIG. 7 have been moved, according to an exemplary embodiment of the present invention. Referring to FIG. 8, the divided sub-menu items 610, 620, 630, and 640 are arranged and moved according to the arrangement pattern of the menu items 410, 420, 430, and 440 in an upper level. That is, similar to the menu items 410, 420, 430, and 440 in an upper level, which are arranged to form a rectangle in the 3D space, the four boxes 610, 620, 630, and 640 are arranged to form a rectangle. In this case, the newly divided sub-menu items 610, 620, 630, and 640 can be displayed as animation so that the newly divided sub-menu items 610, 620, 630, and 640 are moved by pushing the menu items 410, 420, 430, and 440 in an upper level to the backside of the 3D space. In addition, the size of the menu items 610, 620, 630, and 640 in a current depth can be displayed by being gradually increased. As a result, the newly divided sub-menu items 610, 620, 630, and 640 are displayed at the position where the menu items 410, 420, 430, and 440 in an upper level were displayed, and the menu items 410, 420, 430, and 440 in an upper level are pushed back and displayed in a smaller box shape. Thus, the user can easily know a menu depth from the 3D interface screen of FIG. 8.

The invention can also be embodied as computer readable codes on a computer readable recording medium.

As described above, according to the exemplary embodiments of the present invention, instead of simple representation of menu items with 3D icons in a 2D user interface environment, a user can intuitively, easily access and navigate a menu in a 3D space, and menu information and depth can be efficiently displayed.

While this invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of displaying a menu on a screen represented in a three-dimensional (3D) space, the method comprising:
displaying at least one menu item on the screen;
if a menu item is selected, dividing the selected menu item into at least one sub-menu item; and
displaying on the screen the at least one sub-menu item.

2. The method of claim 1, wherein the at least one menu item and the at least one sub-menu item are displayed with a graphic image having a 3D shape.

3. The method of claim 2, wherein the 3D shape is a box shape.

4. The method of claim 3, wherein the dividing comprises dividing a box corresponding to the selected menu item into four boxes corresponding to sub-menu items.

5. The method of claim 1, wherein the displaying of the at least one sub-menu item further comprises arranging the at least one sub-menu item according to an arrangement pattern of the at least one menu item.

6. The method of claim 5, wherein the arranging further comprises displaying the at least one menu item and the at least one sub-menu item so that the at least one sub-menu item is moved by pushing the at least one menu item to a backside of the 3D space.

7. The method of claim 6, further comprising displaying the selected menu item so that the selected menu item is moved to a center or to a front of the 3D space, before the dividing the selected menu item.

8. An apparatus for displaying a menu on a screen represented in a three-dimensional (3D) space, the apparatus comprising:
a display unit which displays the menu;
an input unit which inputs a command; and
a control unit which, if a menu item displayed on the display unit is selected by the command of the input unit, divides the selected menu item into at least one sub-menu item and displays on the display unit the at least one sub-menu item.

9. The apparatus of claim 8, wherein the control unit displays menu items in the menu with a graphic image having a 3D shape.

10. The apparatus of claim 9, wherein the 3D shape is a box shape.

11. The apparatus of claim 10, wherein the control unit divides a box corresponding to the selected menu item into four boxes corresponding to the sub-menu items.

12. The apparatus of claim 8, wherein the control unit arranges the at least one sub-menu item according to an arrangement pattern of menu items in an upper menu level.

13. The apparatus of claim 12, wherein the control unit controls the at least one sub-menu item so that the at least one sub-menu item is moved by pushing the menu items in an upper menu level to a backside of the 3D space.

14. The apparatus of claim 13, wherein the control unit controls the selected menu item so that the selected menu item is moved to a center or to a front of the 3D space, before the selected menu item is divided.

15. A computer readable recording medium storing a computer readable program for executing a method of displaying a menu on a screen represented in a three-dimensional (3D) space, the method comprising:
displaying at least one menu item on the screen as a 3D shape;
if a menu item is selected, displaying the selected menu item so that the selected menu item is moved to a center or to a front of the 3D space and dividing the selected menu item into a 3D shape corresponding to at least one sub-menu item; and
displaying the at least one menu item and the at least one sub-menu item so that the at least one sub-menu item is moved by pushing the at least one menu item to a backside of the 3D space.
